(19) United States
(12) Patent Application Publication
(10) Pub. No.: US 2026/0037402 A1
(43) Pub. Date: Feb. 5, 2026

(54) TIME TRACKING FOR MEMORY APPARATUSES

(71) Applicant: Micron Technology, Inc., Boise, ID (US)

(72) Inventors: Zoltan Szubbocsev, Santa Clara, CA (US); Zheng Wang, Louisville, CO (US)

(21) Appl. No.: 18/790,176

(22) Filed: Jul. 31, 2024

(51) Int. Cl. G06F 11/30

(52) U.S. Cl. CPC G06F 11/3072; G06F 11/3058

(57) ABSTRACT

Time tracking for memory apparatuses is described herein. Time information (e.g., timestamps) received for each power event can be utilized to generate statistical information indicating the duration a computing device has spent in a particular power state. This statistical information can be retrieved by manufacturers for purposes such as data retention analysis.

### TECHNICAL FIELD

Embodiments of the disclosure relate generally to memory systems and sub-systems, and more specifically, relate to time tracking for memory apparatuses.

### BACKGROUND

A memory sub-system can include one or more memory devices that store data. The memory devices can be, for example, non-volatile memory devices and volatile memory devices. In general, a host system can utilize a memory sub-system to store data at the memory devices and to retrieve data from the memory devices.

### BRIEF DESCRIPTION OF THE DRAWINGS

The present disclosure will be understood more fully from the detailed description given below and from the accompanying drawings of various embodiments of the disclosure.

FIG. 1 illustrates an example of a computing system that includes a memory sub-system having a tracking component operating in accordance with some embodiments of the present disclosure.

FIG. 2 illustrates an example of time tracking in accordance with some embodiments of the present disclosure.

FIG. 3 is a flow diagram of an example method for time tracking for memory apparatuses in accordance with some embodiments of the present disclosure.

### DETAILED DESCRIPTION

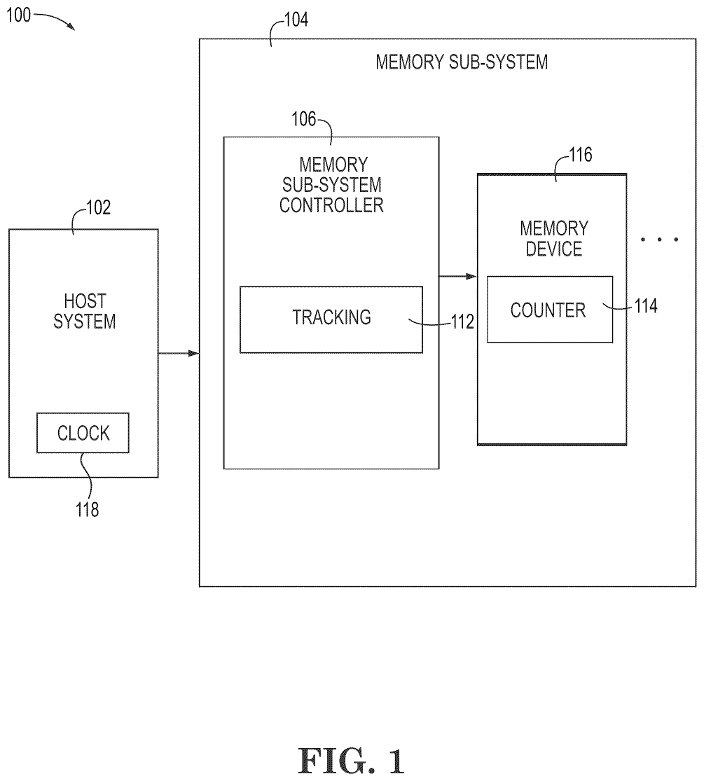

Aspects of the present disclosure are directed to time tracking for memory apparatuses. A memory sub-system can be a storage system, storage device, a memory module, or a combination of such. An example of a memory sub-system is a storage system such as a solid-state drive (SSD), Universal Flash Storage (UFS) drive, etc. Examples of storage devices and memory modules are described below in conjunction with FIG. 1. In general, a host system can utilize a memory sub-system that includes one or more components, such as memory devices that store data. The host system can provide data to be stored at the memory sub-system and can request data to be retrieved from the memory sub-system.

As performance requirements for memory increase, managing data retention has become increasingly important in view of the high power consumption associated with refresh operations on memory systems. Memory systems store data as an electrical charge in memory cells. Over time, the chemical and physical properties of the memory cells change, causing the stored data to change. For example, NAND flash memory stores data in memory cells that retain charge levels to represent binary data, and over time, the charge in these cells can leak, leading to potential data loss or corruption if not refreshed. Accordingly, refresh operations are required periodically in order to retain accurate data in memory systems. However, while refresh operations are being performed on the memory device, memory requests associated with the memory device become unavailable resulting in lowered system performance due to the time it takes to refresh data stored in the memory. Moreover, refresh operations performed while the computing system is not connected to a stable power source (e.g., plugged-in power) can drain the battery, reducing the operating time available for users. Therefore, optimizing the frequency of refresh operations is crucial for maintaining overall system performance and enhancing user experiences.

Aspects of the present disclosure address the above and other issues by tracking time to generate statistical information (e.g., in various formats) that can be readily used for statistically assessing the frequency and duration of a power-off events in the computing system while deployed in the field. As used herein, the term “in the field” refers to situations or environments where equipment or systems are actively deployed or used, often outside of controlled or laboratory settings. This enables ones (e.g., manufacturers) to easily and accurately collect and analyze the time periods during which these devices are powered off, thereby facilitating enhanced data retention analysis. This analysis can be further utilized to determine optimal timing and frequency for performing refresh operations.

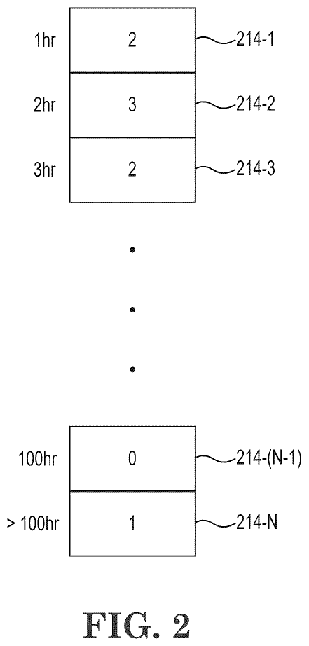

The figures herein follow a numbering convention in which the first digit or digits correspond to the drawing figure number and the remaining digits identify an element or component in the drawing. Similar elements or components between different figures may be identified by the use of similar digits. For example, 114 may reference element “14” in FIG. 1, and a similar element may be referenced as 214 in FIG. 2. Analogous elements within a Figure may be referenced with a hyphen and extra numeral or letter. Such analogous elements may be generally referenced without the hyphen and extra numeral or letter. For example, elements 214-1, 214-2, . . . , 214-N in FIG. 2 may be collectively referenced as 214. As used herein, the designator “N”, particularly with respect to reference numerals in the drawings, indicates that a number of the particular feature so designated can be included. As will be appreciated, elements shown in the various embodiments herein can be added, exchanged, and/or eliminated so as to provide a number of additional embodiments of the present disclosure. In addition, as will be appreciated, the proportion and the relative scale of the elements provided in the figures are intended to illustrate certain embodiments of the present invention and should not be taken in a limiting sense.

FIG. 1 illustrates an example computing system 100 that includes a memory sub-system 104 (alternatively referred to as memory device 104) having a tracking component (e.g., the tracking component 112) operating in accordance with some embodiments of the present disclosure. The computing system 100 can be a computing device such as a desktop computer, laptop computer, network server, mobile device, a vehicle (e.g., airplane, drone, train, automobile, or other conveyance), Internet of Things (IoT) enabled device, embedded computer (e.g., one included in a vehicle, industrial equipment, or a networked commercial device), or such computing device that includes memory and a processing device (e.g., a central processing unit (CPU)).

The computing system 100 includes a host system 102 that is coupled to one or more memory sub-systems 104. In some embodiments, the host system 102 is coupled to different types of memory sub-systems 104. FIG. 1 illustrates an example of a host system 102 coupled to one memory sub-system 104. As used herein, “coupled to” or “coupled with” generally refers to a connection between components, which can be an indirect communicative connection or direct communicative connection (e.g., without intervening components), whether wired or wireless, including connections such as electrical, optical, magnetic, and the like.

The host system 102 includes or is coupled to processing resources, memory resources, and network resources. As used herein, “resources” are physical or virtual components that have a finite availability within a computing system 100. For example, the processing resources include a processing device, the memory resources include memory sub-system 104 for secondary storage and main memory devices (not specifically illustrated) for primary storage, and the network resources include as a network interface (not specifically illustrated). The processing device can be one or more processor chipsets, which can execute a software stack. The processing device can include one or more cores, one or more caches, a memory controller (e.g., NVDIMM controller), and a storage protocol controller (e.g., PCIe controller, SATA controller, etc.). The host system 102 uses the memory sub-system 104, for example, to write data to the memory sub-system 104 and read data from the memory sub-system 104.

The host system 102 can further include a clock component 118 (simply referred to as “clock”). Although not shown in FIG. 1 so as to not obfuscate the drawings, the clock component 118 can include various circuitry to facilitate aspects of the disclosure described herein. In some embodiments, the clock component 118 can include firmware, special purpose circuitry in the form of an ASIC, FPGA, state machine, hardware processing device, and/or other logic circuitry that can allow the clock component 118 to orchestrate and/or perform operations described herein.

In some embodiments, the clock component 118 can be a real-time clock (RTC). As used herein, the term “RTC” or “real-time clock” refers to a computer clock that keeps track of the current time and date, for example, even when the main system power is turned off or not available. Although embodiments are not so limited, the RTC can operate as defined by JEDEC standards, which requires data transfer to memory sub-systems (e.g., memory sub-systems 104) to maintain accurate timekeeping within the device.

The RTC can be powered by a small battery (e.g., CMOS battery), ensuring continuous operation of the RTC. The host system 102 can often utilize wireless communication, a network, etc. to synchronize the clock 118. For example, the host system 102 can utilize a particular protocol (e.g., network time protocol (NTP)) to synchronize the clock 118. More particularly, the host system 102 can periodically connect to NTP servers (which can provide highly accurate time information, often synchronized with atomic clocks or GPS systems) on the network to obtain the correct time.

The host system 102 can utilize clock component 118 to perform various operations and/or run various applications, such as timestamping events, scheduling tasks, maintaining system logs, etc. As further described herein, the memory sub-system 104 can also be provided with time information (e.g., real-time information) via clock component 118.

The host system 102 can run one or more further applications. For instance, the applications can run on an operating system (not specifically illustrated) executed by the host system 102. An operating system is system software that manages computer hardware, software resources, and provides common services for the applications. An application is a collection of instructions that can be executed to perform a specific task.

The host system 102 can be coupled to the memory sub-system 104 via a physical host interface. Examples of a physical host interface include, but are not limited to, a serial advanced technology attachment (SATA) interface, a PCIe interface, universal serial bus (USB) interface, Fibre Channel, Serial Attached SCSI (SAS), Small Computer System Interface (SCSI), a double data rate (DDR) memory bus, a dual in-line memory module (DIMM) interface (e.g., DIMM socket interface that supports Double Data Rate (DDR)), Open not-and (NAND) Flash Interface (ONFI), Double Data Rate (DDR), Low Power Double Data Rate (LPDDR), or any other interface. The physical host interface can be used to transmit data between the host system 102 and the memory sub-system 104. The host system 102 can further utilize an NVM Express (NVMe) interface to access the non-volatile memory devices 116 when the memory sub-system 104 is coupled with the host system 102 by the PCIe interface. The physical host interface can provide an interface for passing control, address, data, and other signals between the memory sub-system 104 and the host system 102. FIG. 1 illustrates a memory sub-system 104 as an example. In general, the host system 102 can access multiple memory sub-systems via a same communication connection, multiple separate communication connections, and/or a combination of communication connections.

The host system 102 can control and/or send requests (e.g., commands) to the memory sub-system 104, for example, to store data in the memory sub-system 104 or to read data from the memory sub-system 104. For example, the host system 102 can use the memory sub-system 104 to provide storage for a black box application. The data to be written or read, as specified by a host request, is referred to as “host data.” A host request can include logical address information. The logical address information can be a logical block address (LBA), which may include or be accompanied by a partition number. The logical address information is the location the host system associates with the host data. The logical address information can be part of metadata for the host data. The LBA may also correspond (e.g., dynamically map) to a physical address, such as a physical block address (PBA), that indicates the physical location where the host data is stored in memory.

A memory sub-system 104 can be a storage device, a memory module, or a hybrid of a storage device and memory module. Examples of a storage device include an SSD, a flash drive, a universal serial bus (USB) flash drive, an embedded Multi-Media Controller (eMMC) drive, a Universal Flash Storage (UFS) drive, a secure digital (SD) card, and a hard disk drive (HDD). Examples of memory modules include a dual in-line memory module (DIMM), a small outline DIMM (SO-DIMM), and various types of non-volatile dual in-line memory module (NVDIMM).

The memory sub-system 104 can include media, such one or more non-volatile memory devices 116, or a combination thereof. An example of non-volatile memory devices 116 include NAND type flash memory. NAND type flash memory includes, for example, two-dimensional NAND (2D NAND) and three-dimensional NAND (3D NAND). The non-volatile memory devices 116 can be other types of non-volatile memory, such as read-only memory (ROM), phase change memory (PCM), self-selecting memory, other chalcogenide based memories, ferroelectric transistor random-access memory (FeTRAM), ferroelectric random access memory (FeRAM), magneto random access memory (MRAM), Spin Transfer Torque (STT)-MRAM, conductive bridging RAM (CBRAM), resistive random access memory (RRAM), oxide based RRAM (OxRAM), negative-or (NOR) flash memory, electrically erasable programmable read-only memory (EEPROM), and three-dimensional cross-point memory. A cross-point array of non-volatile memory can perform bit storage based on a change of bulk resistance, in conjunction with a stackable cross-gridded data access array. Additionally, in contrast to many flash-based memories, cross-point non-volatile memory can perform a write in-place operation, where a non-volatile memory cell can be programmed without the non-volatile memory cell being previously erased.

Each of the non-volatile memory devices 116 can include one or more arrays of memory cells. One type of memory cell, for example, single level cells (SLC) can store one bit per cell. Other types of memory cells, such as multi-level cells (MLCs), triple level cells (TLCs), quad-level cells (QLCs), and penta-level cells (PLCs) can store multiple bits per cell. In some embodiments, each of the non-volatile memory devices 116 can include one or more arrays of memory cells such as SLCs, MLCs, TLCs, QLCs, or any combination of such. In some embodiments, a particular memory device can include an SLC portion, and an MLC portion, a TLC portion, a QLC portion, or a PLC portion of memory cells. The memory cells of the non-volatile memory devices 116 can be grouped as pages that can refer to a logical unit of the memory device used to store data. With some types of memory (e.g., NAND), pages can be grouped to form blocks.

The memory sub-system controller 106 (or controller 106 for simplicity) can communicate with the non-volatile memory devices 116 to perform operations such as reading data, writing data, erasing data, and other such operations at the non-volatile memory devices 116. The memory sub-system controller 106 can include hardware such as one or more integrated circuits and/or discrete components, or a combination thereof. The hardware can include a digital circuitry with dedicated (i.e., hard-coded) logic to perform the operations described herein. The memory sub-system controller 106 can be a microcontroller, special purpose logic circuitry (e.g., a field programmable gate array (FPGA), an application specific integrated circuit (ASIC), etc.), or other suitable circuitry.

In general, the memory sub-system controller 106 can receive information or operations from the host system 102 and can convert the information or operations into instructions or appropriate information to achieve the desired access to the non-volatile memory devices 116. The memory sub-system controller 106 can be responsible for other operations such as wear leveling operations, error detection and/or correction operations, encryption operations, caching operations, and address translations between a logical address (e.g., logical block address) and a physical address (e.g., physical block address) associated with the non-volatile memory devices 116. The memory sub-system controller 106 can further include host interface circuitry to communicate with the host system 102 via the physical host interface. The host interface circuitry can convert a query received from the host system 102 into a command to access the non-volatile memory devices 116 as well as convert responses associated with the non-volatile memory devices 116 into information for the host system 102.

As shown in FIG. 1, the memory sub-system 104 can include tracking component 112. Although not shown in FIG. 1 so as to not obfuscate the drawings, the tracking component 112 can include various circuitry to facilitate aspects of the disclosure described herein. In some embodiments, the tracking component 112 can include firmware, special purpose circuitry in the form of an ASIC, FPGA, state machine, hardware processing device, and/or other logic circuitry that can allow the tracking component 112 to orchestrate and/or perform operations described herein.

The tracking component 112 can utilize time information received at the controller 106 (e.g., from the host system 102) to track and/or generate various parameters associated with the time information. While the memory sub-system 104 or the controller 106 may not include its own clock and/or clocking system, the time information received from the host system 102 in various formats can be managed by the tracking component 112. For example, the host system 102 can communicate time information in forms of “timestamp”. As used herein, the term “timestamp” refers to information of the date and time of day that identifies when a particular event occurred.

In one example, commands (e.g., read/write commands) received from the host system 102 to the controller 106 can include respective timestamps identifying the current time and date associated with the commands. In another example, the host system 102 can send a timestamp itself to the memory sub-system 104 when updating the firmware, allowing the memory sub-system 104 to synchronize its logs and events with the time being tracked by the host system 102.

In a different example, the host system 102 can send a timestamp for each power event (alternatively referred to as “power management event” or “power transition event). For example, the host system 102 can communicate the current time and date (in the form of timestamp) to the memory sub-system 104 when the computing system 100 is put into or about to be put into a different power state (e.g., from active state to inactive state, vice versa). As used herein, the term “inactive state” can be alternatively referred to as “reduced power state”, which can include a power-off state, a sleep state, etc. More particularly, the timestamp associated with power events can be communicated as part of various commands, which can include sleep commands (e.g., “STANDBY IMMEDIATE” Advanced Technology Attachment (ATA) commands, “SET FEATURE” NVMe commands, etc.), flush commands (“FLUSH CACHE” ATA commands, “FLUSH” NVMe commands” etc.), and/or power state change notifications, although embodiments are not so limited.

The tracking component 112 can store time information (e.g., timestamps) to memory devices 116 and generate secondary information (alternatively referred to as statistical information) based on the time information stored in the memory devices 116. Often, particular sections (alternatively referred to as “buckets”) of the memory devices 116 can be dedicated for storing the time information and statistical information. Although embodiments are not so limited, the secondary information can be recorded and stored in the counters 114 of the memory device 116.

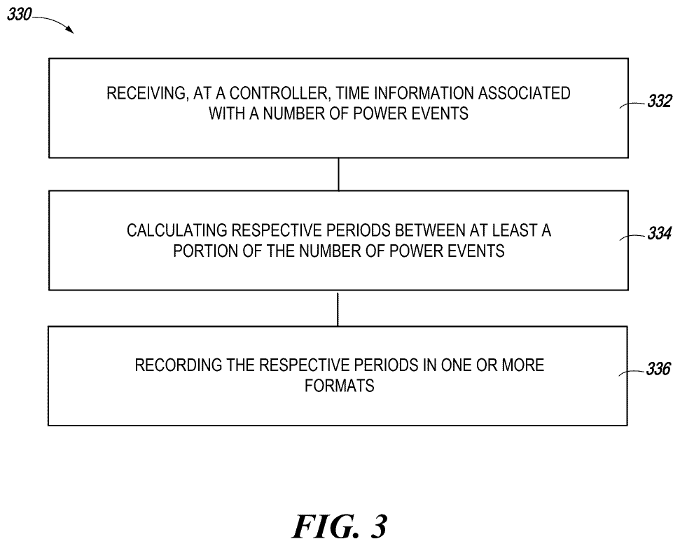

Alternatively, the tracking component 112 can include a memory (e.g., RAM, Flash Memory, EEPROM, non-volatile RAM (NVRAM), SD Card,) that can (e.g., at least temporarily) store the time information and/or generated secondary information. The secondary information can indicate particular parameters, such as duration for which the computing system 100 has been put into an inactive state. In some embodiments, the secondary information can be tracked by utilizing one or more counters (e.g., counter 114). Further details associated with tracking time information and/or generating secondary time information are illustrated in association with FIGS. 2 and 3.

FIG. 2 illustrates an example of time tracking in accordance with some embodiments of the present disclosure. Counters 214-1, . . . , 214-N (collectively referred to as counters 214) illustrated in FIG. 2 can respectively be analogous to the counter 114 illustrated in FIG. 1. For example, counters 214 can be part of the memory device 116 illustrated in FIG. 1.

Each counter 214 can be utilized to respectively track a time period (alternatively referred to as “inactive period” or “power off period”) between two (e.g., consecutive) particular events, such as power transition events. As used herein, the term “inactive period” refers to a time period between two consecutive power transition events, such as between a first event of a power transition from an active to an inactive power state and a following second event of a power transition from an active to an inactive power state.

For example, as shown in FIG. 2, a counter 214-1 can indicate a quantity of inactive periods, with each inactive period being equal to or less than 1 hour; a counter 214-2 can indicate a quantity of inactive periods, with each inactive period being equal to or less than 2 hours (but more than 1 hour); a counter 214-3 can indicate a quantity of inactive periods, with each inactive period being equal to or less than 3 hours (but more than 2 hours); a counter 214-(N−1) can indicate a quantity of inactive periods, with each inactive period being equal to or less than 100 hours (but more than 99 hours); and a counter 214-(N−1) can indicate a quantity of inactive periods, with each inactive period being more than 100 hours. However, embodiments are not limited to a particular value of inactive periods each counter can indicate. For example, while counters 214 illustrated in the example shown in FIG. 2 respectively correspond to different time ranges, with increments of 1 hour, the counters 214 can be utilized to indicate different time ranges with increments of 30 minutes, 2 hours, 3 hours, etc. In the non-limiting example illustrated in FIG. 2, values of the counters 214-1, . . . , 214-N currently indicate two inactive periods that is equal to or less than 1 hour; 3 inactive periods that is equal to or less than 2 hours (but more than 1 hour); two inactive periods that is equal to or less than 3 hours (but more than 2 hours; no inactive periods that is equal to or less than 100 hours (but more than 99 hours); and one inactive period that is more than 100 hours.

The counter values can be incremented for each corresponding inactive period. For example, if the controller (e.g., the controller 106, such as the tracking component 112 illustrated in FIG. 2) determines that the recent inactive period (that has not been recorded to the counters 214 yet) corresponds to equal to or less than 3 hours (but more than 2 hours), the controller 106 can increment (e.g., the value of) the counter 214-3 to record such. More particularly, if the calculated inactive period is determined to be greater than a first threshold (2 hours), but less than a second threshold (3 hours), the controller 106 can record this inactive period to the counter 214-3, which corresponds to a time range between the first threshold and the second threshold.

Each inactive period can be calculated (e.g., by the controller 106) based on time information (e.g., timestamps) associated with respective two (e.g., consecutive) power events: the first event corresponding to a transition from an active to an inactive state and the second event corresponding to a transition from an inactive to an active state. The controller 106 can then calculate the time difference between the two events by subtracting the timestamp value associated with the first event from the timestamp value associated with the second event. More particularly, if the timestamp value associated with the first event is “2024 Jul. 4 14:00:00” and the timestamp value associated with the second event is “2024 Jul. 4 16:30:00”, the inactive period between the two events corresponds to 2:30:00 (2 hours and 30 minutes), which may be recorded to the counter 214-3. The time difference between two timestamp values can correspond to the lapse of time from the preceding timestamp value to the subsequent timestamp value. For example, if the preceding timestamp value is “2024 Jul. 4 14:00:00” and the subsequent timestamp value is “2024 Jul. 4 16:30:00”, the lapse of time between the two timestamp values is 2 hours and 30 minutes. In some embodiments, the inactive period can be calculated upon the occurrence of a subsequent power event, such as a transition from an inactive to an active state.

Alternatively or optionally, the controller 106 can maintain detailed information for each inactive period. For example, if the computing system 100 experienced 40 inactive periods over a particular period of time, the controller 106 can calculate each one of 40 inactive periods as described above and can record (e.g., store) those values of 40 inactive periods in the memory devices (e.g., memory devices 116 illustrated in FIG. 1). While this approach may require more memory space than the approach illustrated in association with FIG. 2, this approach can provide more detailed information regarding inactive periods, which can allow more detailed and/or fine analysis associated with data retention.

The time information and/or the statistical information (e.g., counter values and/or statistical information stored in the memory devices 116) can later be retrieved for further analysis, such as analysis associated with data retention. For example, the time information and/or the statistical information can be retrieved via vendor-specific commands. The analysis can be utilized to determine optimal timing and frequency for performing refresh operations on memory devices 116. The counters 214 can be reset (e.g., programmed to a predetermined value) at specific points, such as when the statistical information is retrieved from the counters 214, or after a predetermined period of time has elapsed.

In some embodiments, the time information and/or the statistical information can be used “on-the-fly”. For example, the controller 106 (e.g., firmware included in the controller 106) can dynamically adjust the timing and frequency for performing refresh operations on the memory devices 116 “on-the-fly” based on this (time and/or statistical) information. Specifically, if the recent power-off period exceeds a particular threshold, the controller 106 can prioritize and adjust the timing and frequency of the refresh operations accordingly.

FIG. 3 is a flow diagram of an example method 330 for managing errors associated with operating a computing system (e.g., the computing system 100 illustrated in FIG. 1) in accordance with some embodiments of the present disclosure. The method can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method is performed by or using the memory sub-system controller 106 (e.g., the tracking component 112 shown in FIG. 1) shown in FIGS. 1, respectively. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At 332, time information associated with a number of power events can be received at a controller (e.g., the controller 106 illustrated in FIG. 1). At 334, respective periods between at least a portion of the number of power events can be calculated.

At 336, the respective periods can be recorded in one or more formats. In one example, the calculated respective periods can be categorized into a number of categories (e.g., respective time ranges, such as 0 to 1 hour, 1 to 2 hour, 2 to 3 hour, etc. illustrated in FIG. 2) based on comparison between each one of the calculated respective periods and a number of thresholds. In this example, a respective quantity of periods of the respective periods can be associated to each one of the number of categories. For example, a respective counter (of a number of counters with each corresponding to a respective category of the number of categories, such as counter 114, 214 illustrated in FIGS. 1 and 2, respectively) corresponding to a particular category can be incremented responsive to a particular period of the respective periods being categorized to the particular category.

In some embodiments, the number of power events can include a number of first power events with each one of the number of first power events corresponding to a respective power transition event from an active state to an inactive state. The number of power events can further include a number of second power events with each one of the number of second power events corresponding to a respective power transition event from an inactive state to an active state.

In this example, calculating the respective periods between the at least the portion of the number of power events can include calculating an inactive period between each first power event of the number of first power events and a respective second power event of the number of second power events. In some embodiments, each one of inactive periods respectively associated with sets of respective first and second power events can be (e.g., individually) recorded, such as in memory (e.g., memory devices 116 illustrated in FIG. 1).

In some embodiments, the time information associated with the number of power events can be stored in memory 116. In this example, the respective inactive period can be calculated based on the time information stored in memory 116. In some embodiments, the inactive period between each first power event of the number of first power events and a respective second power event of the number of second power events can be calculated responsive to occurrence of the respective second power event.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general purpose computer selectively activated or reconfigured by a computer program stored in the computer. Such a computer program can be stored in a machine-readable storage medium, such as, but not limited to, types of disks, semiconductor-based memory, magnetic or optical cards, or other types of media suitable for storing electronic instructions.

The present disclosure can be provided as a computer program product, or software, that can include a machine-readable medium having stored thereon instructions, which can be used to program a computer system (or other electronic devices) to perform a process according to the present disclosure. A machine-readable medium includes a mechanism for storing information in a form readable by a machine (e.g., a computer).

In the foregoing specification, embodiments of the disclosure have been described with reference to specific example embodiments thereof. It will be evident that various modifications can be made thereto without departing from the broader spirit and scope of embodiments of the disclosure as set forth in the following claims. The specification and drawings are, accordingly, to be regarded in an illustrative sense rather than a restrictive sense.

What is claimed is:

1. A method, comprising:
receiving, at a controller, time information associated with a number of power events;
calculating respective periods between at least a portion of the number of power events; and
recording the respective periods in one or more formats.

2. The method of claim 1, wherein the number of power events further comprises:
a number of first power events with each one of the number of first power events corresponding to a respective power transition event from an active state to an inactive state; and
a number of second power events with each one of the number of second power events corresponding to a respective power transition event from an inactive state to an active state.

3. The method of claim 2, wherein calculating the respective periods between the at least the portion of the number of power events further comprises:
calculating an inactive period between each first power event of the number of first power events and a respective second power event of the number of second power events.

4. The method of claim 3, wherein recording the respective periods in one or more formats further comprises:
recording each one of inactive periods respectively associated with sets of respective first and second power events.

5. The method of claim 3, further comprising:
storing the time information associated with the number of power events in a memory; and
calculating each inactive period based on the time information stored in the memory.

6. The method of claim 3, further comprising calculating the inactive period between each first power event of the number of first power events and a respective second power event of the number of second power events responsive to occurrence of the respective second power event.

7. The method of claim 1, wherein recording the respective periods in one or more formats further comprises:
categorizing the calculated respective periods into a number of categories based on comparison between each one of the calculated respective periods and a number of thresholds; and
associating a respective quantity of periods of the respective periods to each one of the number of categories.

8. The method of claim 7, wherein:
the controller is communicatively coupled to a memory comprising a number of counters each corresponding to a respective category of the number of categories; and
the method further comprises incrementing a respective counter corresponding to a particular category of the number of categories responsive to a particular period of the respective periods being categorized to the particular category.

9. An apparatus, comprising:
a memory; and
a controller coupled to the memory, the controller configured to:
sequentially receive time information corresponding to a first power event and time information corresponding to a second power event, wherein the first power event is a preceding power event of the second power event;
calculate a period between the first power event and the second power event; and
record the period in one or more formats.

10. The apparatus of claim 9, wherein the memory further comprises a number of counters, wherein the controller is further configured to:
categorize the calculated period into one of a number of categories based on comparison between the calculated period and a number of thresholds; and
record the period in a particular counter of the number of counters that corresponds to the one of the number of categories.

11. The apparatus of claim 9, wherein:
the first power event corresponds to a power transition event from an active state to an inactive state of the apparatus; and
the second power event corresponds to a power transition event from an inactive state to an active state of the apparatus.

12. The apparatus of claim 9, wherein:
the time information corresponding to the first power event is received as part of a first command to put the apparatus into an inactive state; and
the time information corresponding to the second power event is received as part of a second command to put the apparatus into an active state.

13. The apparatus of claim 9, wherein:
the time information corresponding to the first power event corresponds to a first timestamp; and
the time information corresponding to the second power event corresponds to a second timestamp.

14. The apparatus of claim 13, wherein the controller is configured to subtract a value of the first timestamp from a value of the second timestamp to calculate the period between the first power event and the second power event.

15. The apparatus of claim 9, wherein the controller is configured to record the period in the memory.

16. An apparatus, comprising:
a memory; and
a controller coupled to the memory, the controller configured to:
receive time information corresponding to a number of first power events, wherein each first power event of the number of first power events corresponds to a power transition event from an active state to an inactive state of the apparatus;
receive time information corresponding to a number of second power events, wherein each second power event of the number of second power events corresponds to a power transition event from an inactive state to an active state of the apparatus; and
calculate, to record respective inactive periods, the respective inactive periods between each one of a number of sets of power events, wherein each set of power events comprises one second power event of the number of second power events and a respective first power event of the number of first power events that precedes the one second power event.

17. The apparatus of claim 16, wherein the controller is configured to calculate a respective inactive period of the respective inactive periods in response to occurrence of each second power event of the number of second power events.

18. The apparatus of claim 16, wherein the controller further comprises a number of counters, wherein each counter of the number of counters is indicative of a respective non-overlapped time range.

19. The apparatus of claim 18, wherein the controller is configured to increment a respective counter of the number of counters to record each one of the respective inactive periods.

20. The apparatus of claim 16, wherein the controller is configured to:
store the calculated respective inactive periods individually in the memory to record the respective inactive periods.
